(19) United States
(12) Patent Application Publication
(10) Pub. No.: US 2007/0157824 A1
(43) Pub. Date: Jul. 12, 2007

(54) Cooking device particularly useful for cooking pasta, and hot receptacle holder especially useful therewith

(75) Inventors: Eli Cohen, Lev HaSharon (IL); Ann Grant, New York, NY (US)

Correspondence Address: Martin D. Moynihan;PRTSI, Inc., P.O. Box 16446, Arlington, VA, 22215, US

(73) Assignee: AAC Trade Ltd., New York, NY (US)

(21) Appl. No.: 11/329,105

(22) Filed: Jan. 11, 2006

(51) Int. Cl. A47J 37/12

(52) U.S. Cl. 99/403

(57) ABSTRACT

A cooking device particularly useful for cooking pasta, includes: an elongated receptacle for receiving the pasta to be cooked and water to be heated for cooking the pasta, the receptacle being closed at one end and open at its opposite end; a sieve attached to the open end of the receptacle for removing the water after the pasta has been cooked therein; and a cover attached over the sieve for covering the sieve during the cooking of the pasta, and detachable therefrom to permit removing the water from the receptacle via the sieve after the pasta has been cooked. Detachment of the cover from the sieve is facilitated by inter-engaging cam surfaces effective, upon the initial rotation of the cover, to move the cover axially outwardly with respect to the sieve in order to release to the atmosphere any negative pressure generated within the receptacle by condensation of vapors or cooling of the water. Handling of the receptacle while hot is facilitated by providing the receptacle with an outer sleeve of heat-insulating material, and/or with a heat-insulating handle.

### FIELD AND BACKGROUND OF THE INVENTION

The present invention relates to cooking devices which are particularly useful for cooking pasta, such as spaghetti, macaroni, and the like. The invention also relates to a hot receptacle holder especially useful with such cooking devices.

German Utility Model DE20314004.4 discloses a cooking device particularly useful for cooking pasta, such as spaghetti and macaroni, comprising: an elongated receptacle for receiving the pasta to be cooked and water to be heated for cooking the pasta, the receptacle being closed at one end and open at its opposite end; a sieve attached to the open end of the receptacle for removing the water after the pasta has been cooked therein; and a cover attached over the sieve for covering the sieve during the cooking of the pasta, and removable therefrom to permit removing the water from the receptacle after the pasta as been cooked therein. Such a device has been found to be effective in cooking the pasta by merely pouring hot water, preferably boiling water, into the receptacle containing the pasta, retaining the hot water therein for about 6-7 minutes, and then pouring-out the hot water via the sieve.

However, we have noted a number of drawbacks in such cooking devices. One drawback involves the manner of attaching and detaching the cover from the sieve in order to permit removing the water from the receptacle after the pasta has been cooked. Thus, in the existing device, the cover is merely applied over a recessed central section formed in the sieve over the sieve openings. However, such a cover is difficult to remove when it is desired to pour-out the hot water from the receptacle because the condensation of vapor within the receptacle, or the otherwise cooling of the hot water therein, creates a negative pressure within the receptacle which resists the pull-out of the cover. In addition, if the cover is applied over the sieve while the water is still boiling, a positive pressure within the receptacle tends to unseat the cover from the sieve. Also, if the water is retained in the receptacle until relatively cool in order to reduce the negative-pressure therein, there is a danger that the cover will accidentally become unseated, e.g. by the tipping of the receptacle.

Other difficulties are in manipulating the receptacle when hot, e.g., in order to remove hot water or the cooked product therefrom.

### OBJECTS AND BRIEF SUMMARY OF THE PRESENT INVENTION

An object of the present invention is to provide a cooking appliance having improvements in one or more of the above respects. Another object of the present invention is to provide a hot receptacle holder particularly useful with such cooking devices.

The present invention provides a cooking device particularly useful for cooking pasta, comprising: an elongated receptacle for receiving the pasta to be cooked, and hot water for cooking the pasta, the receptacle being closed at one end and open at its opposite end; a sieve attached to the open end of the receptacle for removing the water after the pasta has been cooked in the receptacle; and a cover overlying the sieve during the cooking of the pasta, and removable therefrom to permit removing the water from the receptacle via the sieve after the pasta has been cooked.

According to one feature of the present invention, the cover is attachable over the sieve by rotating the cover in one direction with respect to the receptacle, and is detachable from the sieve by rotating the cover in the opposite direction.

More particularly, in the described preferred embodiments the sieve and the cover include inter-engaging cam surfaces effective, upon the initial rotation of the cover, to move the cover axially outwardly with respect to the sieve in order to release to the atmosphere any negative pressure generated within the receptacle by the cooling of the hot water therein, and thereby to facilitate the detachment of the cover.

In one described preferred embodiment, a surface of the sieve is formed with a plurality of circumferentially-spaced ramps, and a surface of the cover is formed with a corresponding plurality of circumferentially-spaced recesses for accommodating the ramps in the secured position of the cover. The sieve and the cover further include inter-engaging locking elements effective, upon the rotation of the cover to its securing position, to prevent axial movement of the cover with respect to the sieve and to permit only a rotary movement of the cover with respect to the sieve. In addition, a surface of the sieve is formed with a plurality of circumferentially-spaced hooks, and a surface of the cover is formed with a corresponding plurality of circumferentially-spaced slots to receive the hooks in the secured position of the cover.

As will be described more particularly below, such a construction greatly facilitates the removal of the cover even when the receptacle is hot, and moreover better prevents the accidental detachment of the cover after the boiling water has been introduced into the receptacle, as well as after water has cooled within the receptacle.

In another described preferred embodiment, the cover is rotatably attachable to and detachable from the sieve by inter-engaging threads in the sieve and the cover. This construction also provides advantages over the existing device in the above respects, although in most applications the first-mentioned construction would be preferred.

According to another feature of the present invention, the cooking device further includes an outer sleeve of heat-insulating material enclosing at least a part of the receptacle to facilitate manipulating the receptacle when hot. In one described preferred embodiment, the outer sleeve of heat-insulating material includes a flexible insulating sheet having hook and loop fasteners along its opposite edges, rolled into a cylindrical configuration to enclose the receptacle and retained in such cylindrical configuration by the fasteners. The outer sleeve may be integrally formed with finger and thumb sockets for receiving the fingers and thumb of a user.

According to another aspect of the present invention, there is provided a cooking device particularly useful for cooking pasta, comprising: an elongated receptacle for receiving the pasta to be cooked, and hot water for cooking the pasta, the receptacle being closed at one and open at its opposite end; a sieve attached to the open end of the receptacle for removing the water after the pasta has been cooked in the receptacle; a cover overlying the sieve during the cooking of the pasta, and removable therefrom to permit removing the water from the receptacle via the sieve after the pasta has been cooked; an outer sleeve of heat-insulating material enclosing a part of the receptacle to facilitate manipulating the receptacle when hot; and a handle connected across another part of the receptacle also to facilitate manipulating the receptacle when hot.

According to yet another aspect of the present invention, there is provided a hot receptacle holder comprising a flexible sheet of heat-insulating material having hook and loop fasteners along its opposite edges to permit the sheet to be rolled into a cylindrical configuration to enclose the hot receptacle and to be retained in such cylindrical configuration; the sheet being integrally formed with finger and thumb sockets for receiving the fingers and thumb of a user to facilitate manipulating the receptacle enclosed by the holder when the receptacle is hot.

As will be described more particularly below, such features of the present invention are particularly advantageous in cooking devices of this type not only for facilitating the detachment of the cover in order to remove the hot water and the cooked pasta from the receptacle, but also for handling the receptacle particularly when hot.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a three-dimensional view illustrating one form of cooking device constructed in accordance with the present invention;

FIGS. 2a, 2b and 2c are perspective, sectional and plan views, respectively, of the sieve in the cooking device of FIG. 1;

FIGS. 3a, 3b and 3c are perspective, side and plan views, repectively, of the cover in the cooking device of FIG. 1;

FIG. 4 is an exploded view of another cooking device constructed in accordance with the present invention but omitting the handle;

FIG. 5 illustrates a modification in the construction of the receptacle and the sieve to facilitate the attachment and detachment of the sieve with respect thereto;

FIG. 6 is a fragmentary sectional view illustrating the manner of attaching the sieve of FIG. 5 to the receptacle of FIG. 5;

FIG. 7 is a three-dimensional view illustrating another construction of cooking device in accordance with the present invention;

FIG. 8 illustrates a cooking device constructed in accordance with another aspect of the present invention to include a hot receptacle holder for holding and manipulating the receptacle when hot;

FIG. 9 illustrates the hot receptacle holder of FIG. 8 in an initial flat condition;

FIG. 10 illustrates another cooking device constructed to provide a heat-insulating receptacle holder for manipulating the device when hot;

FIG. 11 illustrates a cooking device according to another aspect of the present invention including a novel handle construction, but with the sieve and cover removed;

FIGS. 12 and 13 illustrate two stages in the assembly of the cooking device of FIG. 11;

FIG. 14 is a side view illustrating another cooking device constructed in accordance with the present invention;

FIG. 15 illustrates the handle and the manner of attaching it to the receptacle in the cooking device of FIG. 14;

FIG. 16 illustrates a cooking device similar to that of FIG. 14 but also including a heat-insulating receptacle holder for handling the receptacle when hot; and

FIG. 17 is an exploded view illustrating the main components of another cooking device constructed in accordance with the present invention to incorporate an electrical heater within the receptacle.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

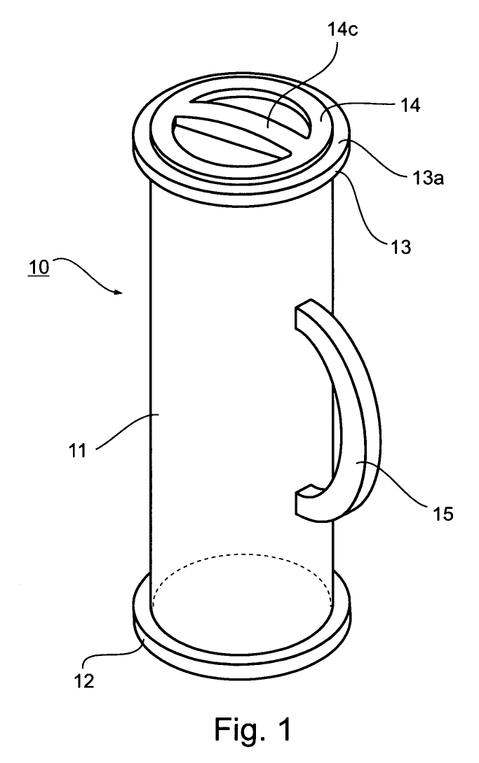

The cooking device illustrated in FIGS. 1-3c, and therein generally designated 10, includes an elongated receptacle 11 for receiving the pasta to be cooked, and also for receiving hot, preferably boiling, water for cooking the pasta. Receptacle 11 is preferably made of a light-transparent heat-resistant plastic material. It is closed at the bottom by base 12. The opposite end of receptacle 11 is normally open. A sieve 13 is removably attached to the open end of the receptacle; and a cover 14 is removably applied to overlie the outer face of sieve 13.

When the illustrated device is used for cooking pasta, such as spaghetti or macaroni, the pasta is introduced into the open end of receptacle 11; the receptacle is filled with hot, preferably boiling, water; sieve 13 is applied over the open end of the receptacle; and cover 14 is applied over the sieve. The pasta is cooked by the hot water in the receptacle for a period of about 6-7 minutes. After the pasta has been cooked, cover 14 is removed, and the receptacle is tipped in order to pour-out the hot water therein through sieve 13 while the sieve retains the pasta within the receptacle. Sieve 13 is then detached from receptacle 11 to enable removing the cooked pasta within the receptacle.

As indicated earlier, in the known cooking device described in the above-cited German Utility Model, the cover 14 is applied merely to rest over the top of the sieve 13 since the cooling of the water within the receptacle, particularly the condensation of the water vapor, creates a negative pressure within the receptacle to hold the cover in place. However, it has been found that the negative pressure produced within the receptacle is such as to securely hold the cover in place against a pull-out force, thereby making it difficult and awkward, and sometimes even painful, to pull out cover 14 while the receptacle is still hot. Another drawback in the existing construction is that when the cover is initially applied, the boiling water within the receptacle may produce such a positive pressure within the receptacle as to unseat the cover when first applied. A further drawback in the existing device is that if the receptacle is accidentally tipped after the cover has been applied, the negative pressure within the receptacle may not be sufficient to prevent the accidental unseating of the cover from the sieve. A still further drawback is that since the receptacle itself is usually very hot at the time the water is introduced or removed, handling of the hot receptacle can also be difficult or painful.

The novel cooking device illustrated in FIGS. 1-3c provides a number of improvements providing a number of advantages in the above respects.

One improvement in the illustrated cooking device is that it includes a handle 15 (FIG. 1) of heat-insulating material attached to the receptacle 11 and dimensioned to receive a user's hand for facilitating the manipulation of the receptacle even when hot.

Another particularly-important improvement in the illustrated cooking device is in the construction of the sieve 13 and cover 14 in order to more securely hold the cover in place during the cooking interval, even if the receptacle is accidentally tipped, and in order to enable detachment of the cover in a more convenient and comfortable manner than in the prior devices even when the cover is hot.

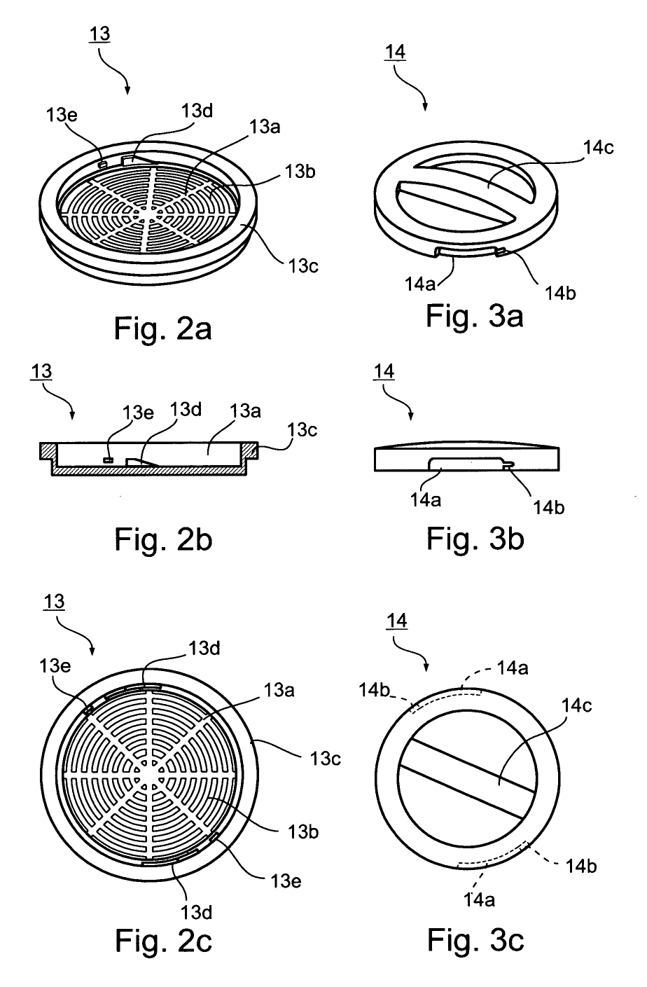

The construction of the sieve 13 and cover 14 is more particularly illustrated in FIGS. 2a-3c. These two elements are constructed such that the cover is securely held on the sieve during the cooking process even though the receptacle is accidentally tipped, and further, that a strong pull-out force is not required as in the prior devices in order to detach the cover from the sieve. In the novel construction illustrated in FIGS. 2a-3c, a relatively small rotating force is needed in order to rotate the cover in one direction to securely attach it to the sieve, and in the opposite direction first to release the cover for axial movement, and then to release the negative pressure within the receptacle in order to permit convenient removal of the cover from the sieve.

Thus, as shown in FIGS. 2a-2c, sieve 13 includes a central recessed section 13a of circular configuration and formed with a plurality of cut-out slots defining sieve openings 13b arrayed in a plurality of circular arrays, to enable the hot water to be removed from the receptacle after the pasta therein has been cooked and the cover 14 removed. Central recessed section 13a is circumscribed by a peripheral rib 13c around recessed section 13a such that the latter section defines a socket of circular configuration for receiving the cover 14.

As further seen in FIGS. 2a-2c, the outer surface of sieve 13 is formed with two inclined ramps 13d on diametrically-opposite sides of the central recess section 13a, and further, with two hook formations 13e adjacent to the high end of each ramp 13d. Each hook formation 13e may be in the form of a short linear hook spaced from the bottom of its respective ramp 13d.

FIGS. 3a-3c illustrate the outer surface of cover 14 cooperable with the ramps 13d and hooks 13e formed in the outer surface of sieve 13. Thus, as shown in FIGS. 3a-3c, the peripheral outer surface of cover 14 is formed at each of its diametrically-opposite sides with an elongated recess 14a terminating at one end with a slot 14b.

The arrangement is such that when cover 14 is initially placed within the central recessed section 13a of sieve 13, cover 14 may be manually rotated in one direction to seat the two ramps 13d in the sieve within slots 14a of the cover, and with the hooks 13e of the sieve received within slots 14b of the cover. This is the securing position of the cover, wherein the hooks 13e of the sieve received within slots 14b of the cover securely hold the cover against any outward axial movement, but permit rotary movement of the cover with respect to the sieve. The initial rotary movement of the cover unseats hooks 13e of sieve 13 from slots 14b of the cover, thereby permitting outward axial displacement of the cover. Continued rotary movement of the cover causes the outer surface of the cover to cam against the inclined ramps 13d, to axially displace the cover from the sieve, to thereby release any negative pressure within the receptacle caused by condensation of water vapor and/or cooling of the water therein.

It will thus be seen that hooks 13e in sieve 13, and notches 14b in cover 14, serve as inter-engaging locking elements effective to positively hold the cover in place on the sieve against outward displacement therefrom, e.g. by a positive pressure within the receptacle or accidental tipping of the receptacle, but permit manual rotation of the cover when desired to remove it from the sieve. It will also be seen that ramps 13d on the sieve cooperate with the outer surface of the cover to define inter-engaging cam surfaces effective, upon the initial rotation of the cover, to move the cover axially outwardly with respect to the sieve in order to release to the atmosphere any negative pressure generated within the receptacle, and thereby to permit the manual removal of the cover in a convenient and easy manner even when the cover is hot.

To facilitate manual rotation of cover 14, it is provided with a diametrically-extending finger piece 14c on its outer face. Finger piece 14c may be grasped by the user to rotate the cover in one direction to attach it to the sieve, and in the opposite direction to detach it from the sieve.

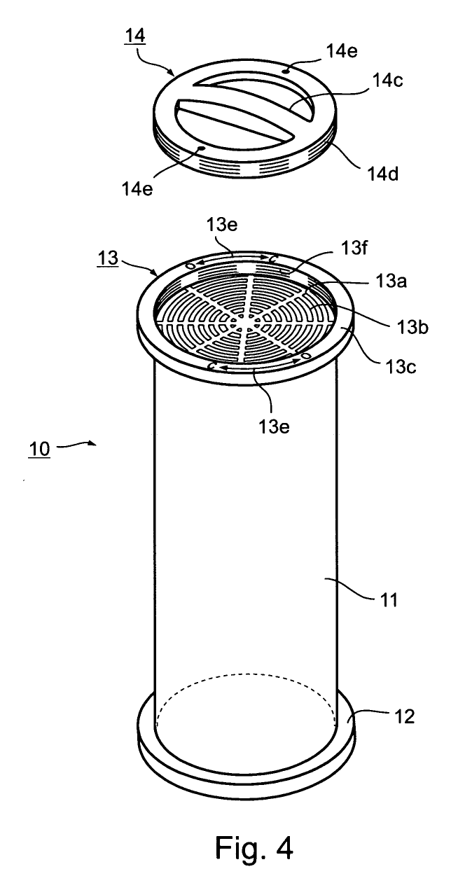

FIG. 4 illustrates another construction for removably attaching cover 14 to sieve 13 by manually rotating the cover with respect to the sieve. Thus, as shown in FIG. 4, the outer face of cover 14 received within the central recessed section 13a of the sieve is formed with threads 14d, and the inner face of rib 13c of the sieve is formed with complementary threads 13f. Cover 14 is thus quickly attachable and detachable from sieve 13 by inserting the cover into the socket defined by the central recess 13a of the sieve, and rotating the cover in one or the other direction.

In FIG. 4, cover 14 further includes dot marking 14e cooperating with indicia markings 13g on rib 13c to indicate the open and closed positions of the cover with respect to the sieve. It will be appreciated that similar indicia markings are preferably provided on the sieve and cover illustrated in FIGS. 1-3c.

Sieve 13 may be attached to receptacle 11 in a similar manner as illustrated in FIG. 4, i.e. by providing complementary threads on each. Sieve 13 may also be attachable to receptacle 11 by a press-fit, similar to the manner in the above-cited German Utility Model, by providing the inner surface of the outer rib 13 with an annular recess (not shown) dimensioned to receive the upper circular edge of receptacle 11 with a press-fit.

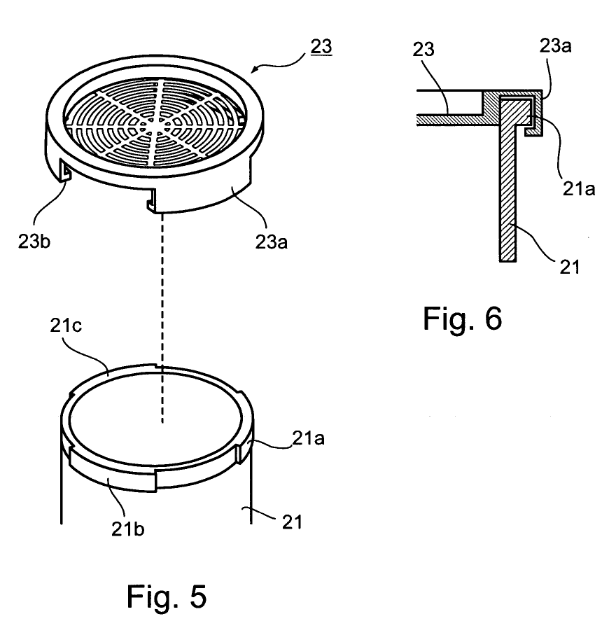

Preferably, however, the manner of attaching the sieve to the receptacle and detaching it from the receptacle is as illustrated in FIGS. 5 and 6.

Thus, as shown in FIG. 5, the open end of the receptacle, therein designated 21, is formed with a plurality of circumferentially-spaced flanges 21a-21c; and the sieve 23 is similarly formed with a plurality of circumferentially-spaced flanges (only two of which, 23a, 23b, are shown in FIG. 5) inter-engageable with flanges 21a-21c of the receptacle. Sieve 23 is applied to the receptacle 21 by locating the sieve flanges in the spaces between the receptacle flanges 21a-21c, pressing the sieve against the open end of the receptacle, and then rotating the sieve so as to cause its flanges to underlie flanges 21a-21c of the receptacle, as shown in FIG. 6. Thus, a simple manual rotation of the sieve in one direction securely attaches it to the receptacle, and in the opposite direction detaches it from the receptacle.

The manner of using the cooking devices illustrated in FIGS. 1-6 will be apparent from the above description. Thus, when the device is to be used for cooking pasta, such as spaghetti or macaroni, both the sieve (13, 23) and the cover (14) are removed; the pasta is introduced into the receptacle (11, 21); the receptacle is then filled with hot, preferably boiling, water; the sieve is applied over the open end of the receptacle; and the cover is then applied over the sieve. As indicated earlier, the cover may be conveniently applied by grasping finger piece 14c and rotating the cover within recessed section 13a of the sieve.

Where the ramp-and-hook construction illustrated in FIGS. 2a-3c is used, the cover is securely held against accidental unseating by the hooks 13e of the sieve received within slots 14b of the cover. Thus, the initial rotation of the cover will unseat the hooks from the slots, and the continued rotation of the cover will displace the cover axially outwardly by the camming action produced by ramps 13d of the sieve, to thereby release the negative pressure within the receptacle. Both actions can be effected in a simple and convenient manner by the user even when the cover is hot. Where mating threads are used, as shown in FIG. 4, a similar rotary movement may be performed for attaching and removing the cover with respect to the sieve. In either case, the closed condition of the cover is indicated by markings 13g on sieve 13, and markings 14e on cover 14, as shown in FIG. 4.

The hot water is retained within the receptacle for a sufficient time (e.g., 6-7 minutes) to cook the pasta therein. After the pasta has been cooked, cover 14 is detached from the sieve 13 (or 23) by grasping handle 15 with one hand and cover finger piece 14c with the other hand, and rotating the cover with respect to the sieve 13 to the open position, as shown by markings 14e and 13g on the cover and sieve. Even though the receptacle 11 and the cover 14 are hot, this can be conveniently and comfortably done because of the insulated handle for grasping the receptacle, and the relatively small force required for rotating cover 14 with respect to the sieve 13.

After the cover 14 has thus been removed, handle 15 may be also be used for tipping the receptacle in order to remove the water via the sieve 13, while the cooked pasta is retained within the receptacle.

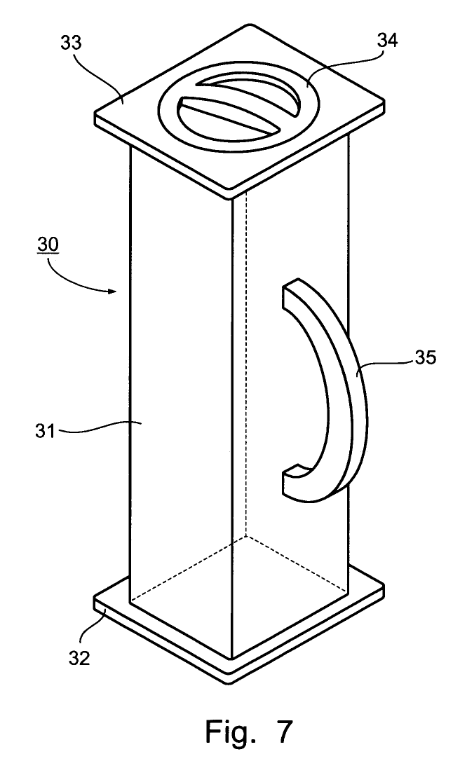

Receptacle 11 in the above-described cooking device is shown as being of a cylindrical configuration. It will be appreciated that it could be of other configurations. FIG. 7 illustrates a cooking device, therein generally designated 30, in which the receptacle 31 is of a rectangular configuration in cross-section, preferably a square configuration having four equal sides. The base 32 enclosing one end of receptacle 31, and sieve 33 at the opposite end of the receptacle, would similarly be of a square configuration. In such case, sieve 33 would be applied to the open end of receptacle 31 by a press fit.

However, cover 34 enclosing the sieve is of a circular configuration as shown to permit its attachment and detachment by relatively small rotational movements, as described above with respect to FIGS. 1-4. In such case, the central recessed section within sieve 33, defining the socket receiving the cover 34, would be of circular configuration in order to rotatably receive the cover. Thus, in the cooking device illustrated in FIG. 7, cover 34 would be attached to and detached from sieve 33 also by a relatively small rotational force in the same manner as described above with respect to FIGS. 1-4.

The cooking device illustrated in FIG. 7 also includes an insulated handle 35 to facilitate handling of the receptacle even when hot.

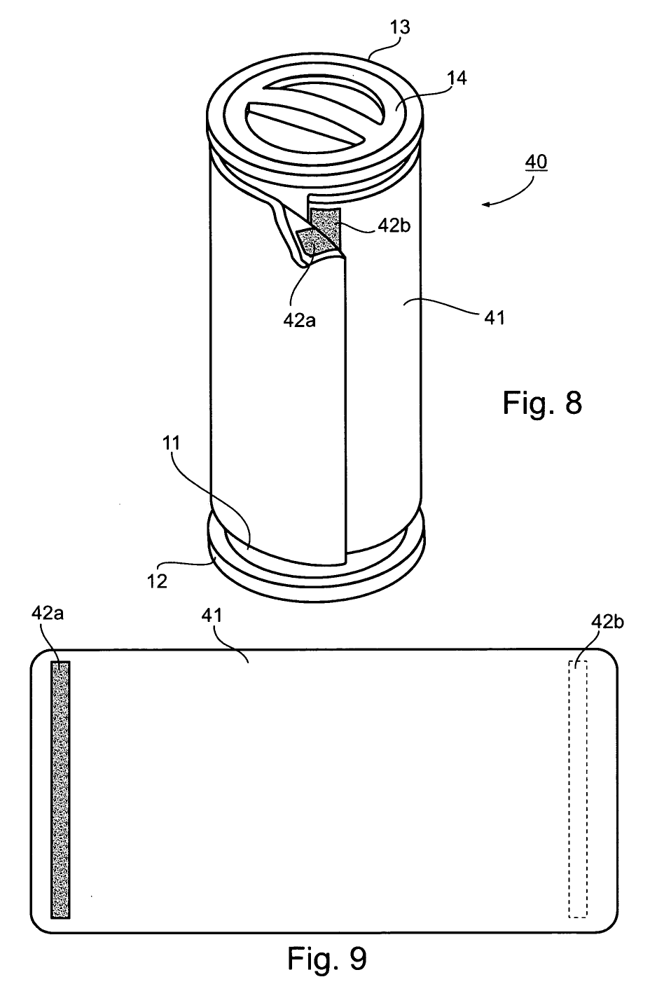

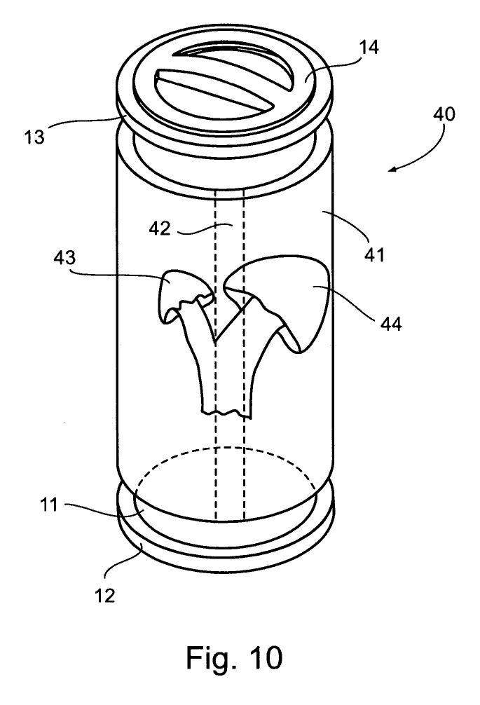

FIG. 8 illustrates a cooking device also constructed in accordance with the present invention but including another means for comfortably holding receptacle 11 when hot. In the construction illustrated in FIG. 8, the cooking device, therein designated 40, is of the same construction as described above except that the heat-insulated handle 15 has been omitted. To facilitate handling the receptacle 11 even when hot, the cooking device includes an outer sleeve 41 of heat-insulating material enclosing the receptacle. As shown in FIG. 9, sleeve 41 is constituted of a flexible sheet of heat-insulating material containing “Velcro” type hook and loop fasteners, schematically shown at 42a, 42b, along its opposite edges, to permit the sheet to be rolled into a cylindrical configuration to enclose the receptacle 11 and to be retained in such cylindrical configuration.

FIG. 10 illustrates a variation in the cooking appliance of FIG. 8, wherein the outer sleeve of heat-insulating material 41 is integrally formed with sockets 43 and 44 for receiving the thumb and fingers, respectively, of the user, thereby facilitating the manipulation of the receptacle even when hot. In FIG. 10, the fasteners 42a, 42b are schematically shown at 42.

In all other respects, the cooking devices illustrated in FIGS. 8 and 10 may be constructed in the manner as described with respect to FIGS. 1-8, and therefore the same reference numerals have been used to identify corresponding parts.

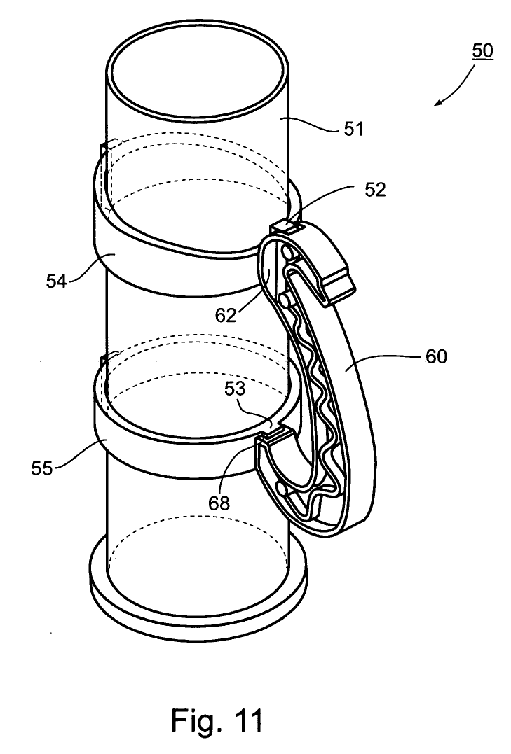

FIGS. 11-13 illustrate another construction of cooking device, therein generally designated 50, wherein the receptacle 51 also includes a handle 60 of heat-insulating material removably attachable to the receptacle and dimensioned to receive a user's hand for manipulating the receptacle even when hot. To simplify the drawings, the sieve 13 and cover 14 are not shown, but it will be appreciated that such a sieve and cover would be applied to receptacle 51 in the same manner as described above with respect to FIGS. 1-4.

In the cooking device illustrated in FIGS. 11-13, handle 60 is removably attachable to receptacle 51 by means of a pair of axially-aligned, longitudinally-spaced projections 52, 53, carried by fabric or plastic straps 54 and 55 applied to the outer face of receptacle 51, which projections are receivable within connectors 62, 63 at the opposite ends of handle 60.

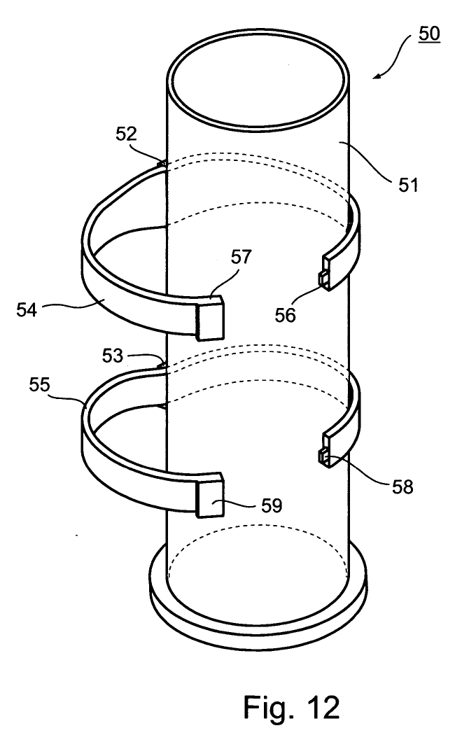

As shown particularly in FIG. 12, straps 54 and 55, carrying projections 52 and 53, respectively, are removably attachable to receptacle 51. For this purpose, strap 54 includes mating clips 56, 57 at its opposite ends; and similarly, strap 55 includes mating clips 58, 59 at its opposite ends.

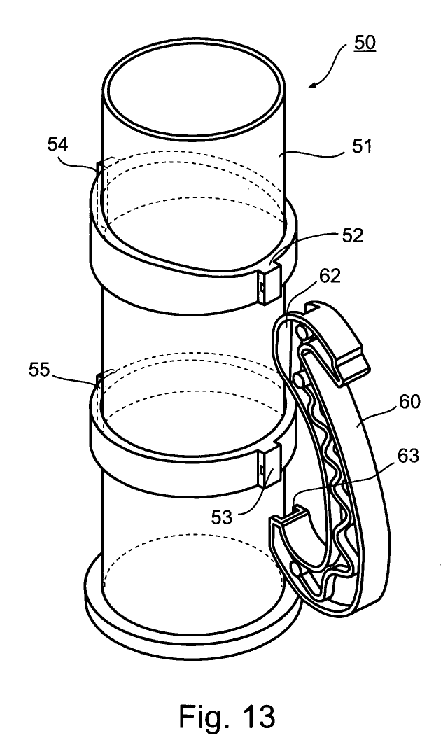

FIG. 13 more fully illustrates the manner of assembling the two straps 54, 55 to the outer face of receptacle 51, and then applying handle 60 to the projections 52, 53 carried by the straps. Thus, as shown in FIG. 13, the two straps 54, 55 are applied around the outer surface of receptacle 52, at axially-spaced locations thereof and with the two projections 52, 53 in axial alignment with each other. When the two projections 52, 53 are so aligned, the straps are attached by snapping clip 56 of strap 54 into its clip 57, and snapping clip 58 of strap 55 into its clip 59. After the two straps have thus been attached, handle 60 is grasped by the user, with its connectors 62, 63 aligned with the two projections 52, 53, and the handle is then moved upwardly in order to seat the two projections 52, 53 in connectors 62, 63. It will be appreciated that the handle may be disassembled by merely reversing the sequence of the above-described actions.

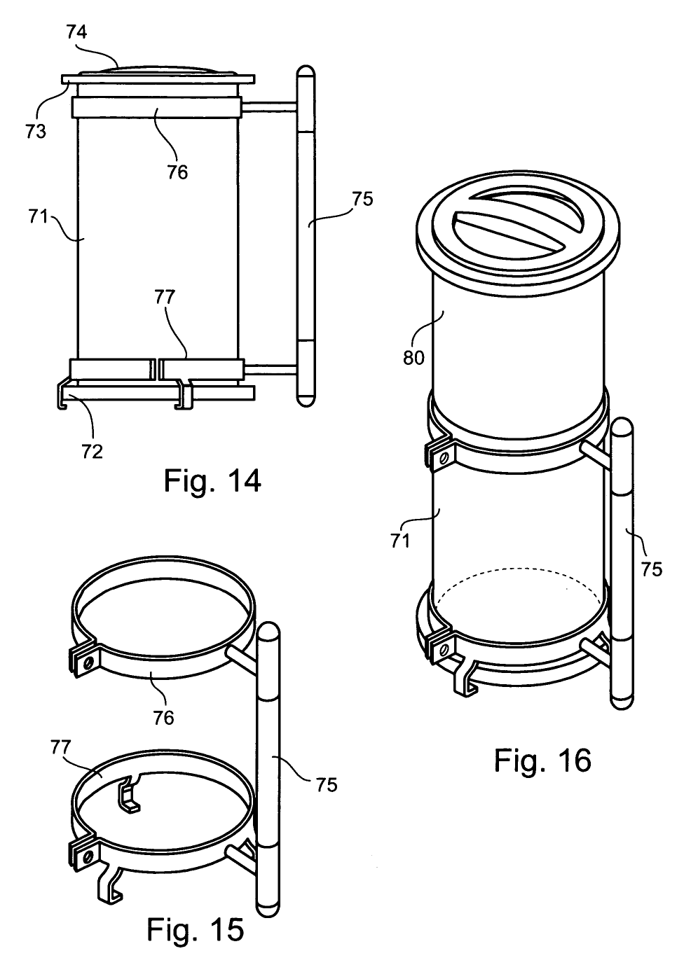

FIG. 14 illustrates another cooking device constructed in accordance with the present invention, including a receptacle 71, having a flat base 72 at one end, and open at the opposite end, which open end is closed by a sieve 73 and cover 74 of any of the above-described constructions. In this case, the cooking device also includes a heat-insulating handle 75 attached to the receptacle 71 by a pair of metal bands 76, 77 applied to the opposite ends of the receptacle and connected to the opposite ends of the handle.

FIG. 16 illustrates a similar cooking device, except that it further includes an outer sleeve 80 of heat-insulating material enclosing a portion the receptacle 71. In this case, the outer sleeve of heat-insulating material 80 covers the upper portion (e.g. one-third to one-half) of the receptacle 71, whereas the handle 75 also of heat-insulating material, extends across the lower portion of the receptacle. Such a construction facilitates handling the receptacle, even when hot, by grasping either or both the heat-insulating sleeve 80 and the handle 75.

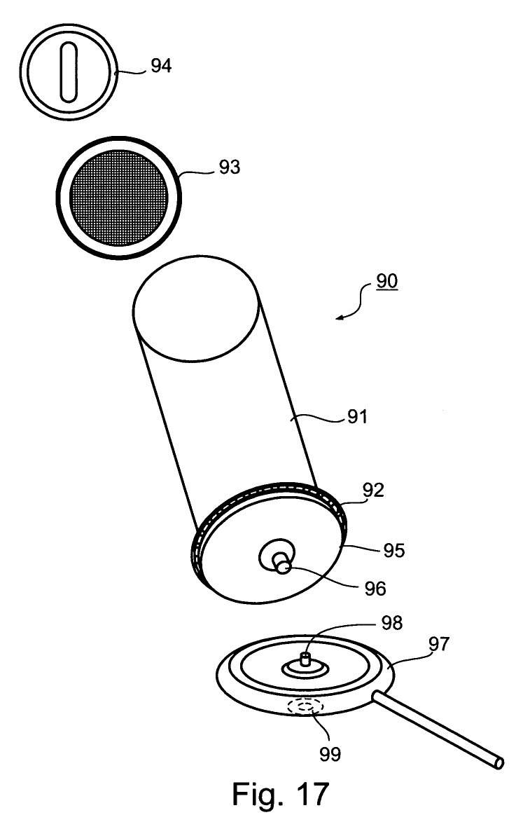

FIG. 17 illustrates another cooking device generally designated 90, constructed in accordance with the present invention and incorporating an electrical heater within the receptacle 91. Receptacle 91 is closed at one end by an enlarged base 92, and at the opposite end by a sieve 93 and a cover 94, as described above with respect to FIGS. 1-4. In this case, however, the base 92 includes an electrical heater 95, and electrical contacts 96 for energizing the electrical heater. The illustrated cooking device further includes a stand 97 for supporting receptacle 91, and having electrical contacts 98 located so as to engage electrical contacts 97 of receptacle 91 when supported on the stand, and thereby to energize the electrical heater 95 within base 92 of the receptacle. Stand 97 further includes a manual switch 99 which may be manually turned on when it is desired to energize the electrical heater within base 92, and is preferably automatically turned-off when the temperature of the water within receptacle 91 reaches a predetermined value, as in electrical coffee pots, for example. In all other respects, the cooking device illustrated in FIG. 17 may be constructed as described above.

While the invention has been described with respect to several preferred embodiments, it will be appreciated that these are set forth merely for purposes of example, and that many other variations, modifications and applications may be made.

What is claimed is:

1. A cooking device particularly useful for cooking pasta, comprising:
an elongated receptacle for receiving the pasta to be cooked and hot water for cooking the pasta, said receptacle being closed at one end and open at its opposite end;
a sieve attached to said open end of the receptacle for removing the water after the pasta has been cooked in the receptacle;
and a cover overlying said sieve during the cooking of the pasta, and detachable therefrom to permit removing the water from the receptacle via the sieve after the pasta has been cooked;
said cover being attachable over said sieve by rotating the cover in one direction with respect to said receptacle, and detachable from said sieve by rotating the cover in the opposite direction.

2. The cooking device according to claim 1, wherein said sieve and said cover include inter-engaging cam surfaces effective, upon the initial rotation of said cover, to move the cover axially outwardly with respect to said sieve in order to release to the atmosphere any negative pressure generated within the receptacle by the cooling of the hot water therein, and thereby to facilitate the detachment of said cover.

3. The cooking device according to claim 2, wherein said inter-engaging cam surfaces include a ramp formed on one of the sieve or cover engageable by a surface of the other of the sieve and cover, which latter surface is formed with a recess for accommodating the ramp in the secured position of said cover.

4. The cooking device according to claim 3, wherein a surface of said sieve is formed with a plurality of circumferentially-spaced ramps, and a surface of the cover is formed with a corresponding plurality of circumferentially-spaced recesses for accommodating said ramps in the secured position of said cover.

5. The cooking device according to claim 2, wherein said sieve and said cover further include inter-engaging locking elements effective, upon the rotation of said cover to its securing position, to prevent axial movement of said cover with respect to said sieve and to permit only a rotary movement of said cover with respect to said sieve.

6. The cooking device according to claim 5, wherein said inter-engaging locking elements comprise a hook on one of the sieve and cover receivable within a slot on the other of the sieve and cover in the secured position of said cover with respect to said sieve.

7. The cooking device according to claim 6, wherein a surface of said sieve is formed with a plurality of circumferentially-spaced hooks, and a surface of the cover is formed with a corresponding plurality of circumferentially-spaced slots to receive said hooks in the secured position of said cover with respect to said sieve.

8. The cooking device according to claim 5, wherein said inter-engaging cam surfaces include a ramp formed in a surface of said sieve engageable with a surface of said cover, which latter surface is formed with a recess for receiving said ramp in the secured position of the cover;
and wherein said inter-engaging locking elements include a hook formed in said surface of the sieve adjacent to one end of said ramp, and a slot formed in said surface of the cover at one end of said recess.

9. The cooking device according to claim 1, wherein said cover is rotatably attachable to and detachable from said sieve by inter-engaging threads in said sieve and said cover.

10. The cooking device according to claim 1, wherein said sieve is rotatably attachable to and detachable from said receptacle by inter-engaging threads formed in said sieve and receptacle.

11. The cooking device according to claim 1, wherein said sieve is rotatably attachable to and detachable from said receptacle by a plurality of circumferentially-spaced interengageable flanges formed in said sieve and said receptacle.

12. The cooking device according to claim 1, wherein said cover includes a diametrically-extending finger-piece on the external surface of the cover graspable by the fingers of a user to rotate the cover in one or the other direction for attaching or detaching the cover.

13. The cooking device according to claim 1, wherein said cooking device includes an outer sleeve of heat-insulating material enclosing at least a portion of said receptacle to facilitate manipulating the receptacle when hot.

14. The cooking device according to claim 13, wherein said outer sleeve of heat-insulating material includes a flexible insulating sheet having hook and loop fasteners along its opposite edges, rolled into a cylindrical configuration to enclose the receptacle and retained in such cylindrical configuration by said fasteners.

15. The cooking device according to claim 13, wherein said outer sleeve is integrally formed with finger and thumb sockets for receiving the fingers and thumb of a user.

16. The cooking device according to claim 1, wherein said receptacle includes a pair of axially-aligned, longitudinally-spaced projections on its outer face, and said handle having connectors at its opposite ends for engagement with said projections.

17. The cooking device according to claim 16, wherein said axially-aligned, longitudinally-spaced projections are carried by a pair of straps removably attachable around said receptacle, and wherein each of said straps includes mating clips at its opposite ends for removably attaching the respective strap around the receptacle.

18. The cooking device according to claim 1, wherein said receptacle includes a pair of axially-aligned, longitudinally-spaced metal bands applied to its outer surface, and a handle having its opposite ends connected to said bands.

19. The cooking device according to claim 1, wherein said cooking device includes an outer sleeve of heat-insulating material enclosing a portion of said receptacle, and a handle of heat-insulating material joined at its opposite ends to said receptacle to extend across the remaining portion of said receptacle.

20. The cooking device according to claim 19, wherein said outer sleeve of heat-insulating material encloses the upper portion of said receptacle, and said handle extends across the lower portion of said receptacle.

21. The cooking device according to claim 1, wherein said receptacle incorporates an electrical heater for heating water therein, and wherein said cooking device further comprises a stand for receiving said receptacle and having electrical contacts for energizing said electrical heater.

22. A cooking device particularly useful for cooking pasta, comprising:
an elongated receptacle for receiving the pasta to be cooked and water to be heated for cooking the pasta, said receptacle being closed at one end and open at its opposite end;
a sieve attached to said open end of the receptacle for removing the water after the pasta has been cooked therein;
a cover attached over said sieve for covering the sieve during the cooking of the pasta, and detachable therefrom to permit removing the water from the receptacle after the pasta has been cooked therein;
and an outer sleeve of heat-insulating material enclosing at least a part of said receptacle to facilitate manipulating the receptacle when hot.

23. The cooking device according to claim 22, wherein said outer sleeve of heat-insulating material includes a flexible insulating sheet having hook and loop fasteners along its opposite edges rolled into a cylindrical configuration to enclose the receptacle, and retained in such cylindrical configuration by said fasteners.

24. The cooking device according to claim 22, wherein said outer sleeve is integrally formed with finger and thumb sockets for receiving the fingers and thumb of a user.

25. A cooking device particularly useful for cooking pasta, comprising:
an elongated receptacle for receiving the pasta to be cooked, and hot water for cooking the pasta, said receptacle being closed at one and open at its opposite end;
a sieve attached to said open end of the receptacle for removing the water after the pasta has been cooked in the receptacle;
a cover overlying said sieve during the cooking of the pasta, and removable therefrom to permit removing the water from the receptacle via the sieve after the pasta has been cooked;
an outer sleeve of heat-insulating material enclosing a part of said receptacle to facilitate manipulating the receptacle when hot;
and a handle connected across another part of said receptacle also to facilitate manipulating the receptacle when hot.

26. The cooking device according to claim 25, wherein said outer sleeve of heat-insulating material encloses the upper portion of said receptacle, and said handle extends across the lower portion of said receptacle.

27. A hot receptacle holder comprising a flexible sheet of heat-insulating material having hook and loop fasteners along its opposite edges to permit the sheet to be rolled into a cylindrical configuration to enclose the hot receptacle and to be retained in such cylindrical configuration; said sheet being integrally formed with finger and thumb sockets for receiving the fingers and thumb of a user to facilitate manipulating the receptacle enclosed by the holder when the receptacle is hot.
